(19) United States
(12) Patent Application Publication
(10) Pub. No.: US 2025/0196263 A1
(43) Pub. Date: Jun. 19, 2025

(54) GAP FINISHING SYSTEM AND METHOD FOR A CAR BODY USING A LOW-OUTPUT LASER

(71) Applicants: HYUNDAI MOTOR COMPANY, Seoul (KR); KIA CORPORATION, Seoul (KR)

(72) Inventors: Beomsuk Oh, Hwaseong-si (KR); Sangbaek Lee, Hwaseong-si (KR)

(73) Assignees: HYUNDAI MOTOR COMPANY, Seoul (KR); KIA CORPORATION, Seoul (KR)

(21) Appl. No.: 18/825,141

(22) Filed: Sep. 5, 2024

(30) Foreign Application Priority Data
Dec. 14, 2023 (KR) 10-2023-0181758

(51) Int. Cl. B23K 26/08; B23K 26/70; B25J 15/00

(52) U.S. Cl. CPC B23K 26/0884; B23K 26/706; B25J 15/0019

(57) ABSTRACT

A gap finishing system and method for a car body using a low-output laser are provided. The gap finishing system includes: a fixing jig unit regulating the car body seated at a set position for gap finishing work through a clamp; a laser head emitting a low-output laser beam to a gap area of the car body for three-dimensional processing to prevent a flow of an electrodeposition liquid; a laser oscillator supplying a low-output laser light source to the laser head; a gas sprayer spraying a shielding gas to a position where the laser beam is emitted; and a controller controlling operation of the three-dimensional processing by moving the laser head mounted on an end effector of an articulated robot to the gap area of the car body.

### CROSS-REFERENCE TO RELATED APPLICATION

This application claims priority to and the benefit of Korean Patent Application No. 10-2023-0181758 filed in the Korean Intellectual Property Office on Dec. 14, 2023, the entire contents of which are incorporated herein by reference.

### BACKGROUND

### (a) Technical Field

The present disclosure relates to a gap finishing system and method for a car body using a low-output laser, and more particularly, to a gap finishing system and method for a car body using a low-output laser to prevent an electrodeposition flow on the car body.

### (b) Description of the Related Art

Generally, in an automobile production plant, an electrodeposition coating process for forming a coating film is performed to prevent an assembled car body from being corroded, and to improve sound insulation, rust prevention, and exterior quality.

In the electrodeposition coating process, after dipping a bar body (body with white, i.e., BIW) into an electrodeposition liquid to apply the electrodeposition liquid to the car body, followed by application of electricity, a washing process is performed to wash away the electrodeposition liquid remaining on the car body. However, even after the washing process is performed multiple times, the electrodeposition liquid may remain in fine gaps of the car body or inside the car body, which causes an electrodeposition flow, resulting in a deterioration in quality of a painted outer panel. The electrodeposition flow refers to a phenomenon in which the electrodeposition liquid remaining in the fine gaps boils up and scatters or flows down on the outer panel of the car body, causing contaminating, during a process of drying the car body in an oven after the electrodeposition process. In other words, the electrodeposition flow is a major cause of the deterioration in quality of the painted outer panel.

As a conventional way to solve this problem, to prevent an electrodeposition flow, an air blower nozzle is arranged for each area of a car body where an electrodeposition flow occurs to spray high-pressure air so that the remaining liquid is blown out. However, in a mixed production line that produces vehicles in multiple models with electrodeposition flows occurring at many locations, there is a problem in that it is difficult to apply a separate nozzle because the location where electrodeposition flow occurs varies between different vehicle models.

In addition, there is a problem in that it is difficult to blow out all the remaining liquid in a section where the liquid exists in a long internal gap, such as a door frame or a hemming part of a hood. The cycle time also increases.

The above information disclosed in this Background section is only to enhance understanding of the background of the disclosure. Therefore, the Background section may include information that does not form the prior art already known to those having ordinary knowledge or skill in the art to which this technology pertains.

### SUMMARY

The present disclosure attempts to provide a gap finishing system and method for a car body using a low-output laser. The system and method are capable of reducing paint defects and improving the exterior quality of the car body by finishing a gap in the car body using a low-output laser to prevent a paint electrodeposition flow.

Further, the present disclosure attempts to provide a gap finishing system and method for a car body capable of stable low-output laser welding by absorbing (i.e., accommodating or compensating for) a car body assembling tolerance and a robot error without a separate tracking device or technology when gap finishing work on the car body using a low-output laser is automated.

An embodiment of the present disclosure provides a gap finishing system for a car body using a low-output laser. The gap finishing system includes a fixing jig unit configured to regulate the car body seated at a set position for gap finishing work through a clamp. The gap finishing system also includes a laser head configured to emit a low-output laser beam to a gap area of the car body for three-dimensional processing to prevent a flow of an electrodeposition liquid. The gap finishing system further includes a laser oscillator configured to supply a low-output laser light source to the laser head. The gap finishing system also includes a gas sprayer configured to spray a shielding gas to a position where the laser beam is emitted. In addition, the gap finishing system includes a controller configured to control operation of the three-dimensional processing by moving the laser head mounted on an end effector of an articulated robot to the gap area of the car body.

The fixing jig unit may include a first jig on which a first car body is mounted on a left-hand (LH) side and a second jig on which a second car body is mounted on a right-hand (RH) side. The first jig and the second jig may be arranged (e.g., placed) symmetrically with respect to the robot.

During the gap finishing work, the robot may transport the laser head to the gap area of the car body and move the laser head along a finishing path set by gap section motion teaching.

During the gap section motion teaching, the robot may create the finishing path by setting a plurality of welding positions with a laser pointer attached to the laser head and by connecting the plurality of welding positions to one another.

The robot may set a finishing path for each gap area of a first door and then may set a finishing path for each gap area of a second door having a structure symmetrical to the first door such that the finishing path for each gap area of the second door is the same as the finishing path for each gap area of the first door in a mirroring manner (e.g., the same as the mirrored finishing path for each gap area of the first door).

The robot may perform focal position teaching for finely adjusting a focal position of the laser beam from the laser head in a width direction of the finishing path and focal diameter teaching for adjusting a distance to the gap area.

The laser head may remotely emit the low-output laser beam to the gap area formed at each of various positions based on a structure of the car body to partially melt the gap area such that the gap area is processed to be blocked.

The low-output laser beam may process a local area corresponding to the gap area with low-amount heat of 1 KW or less. The laser head may remotely emit the low-output laser beam processing a local area corresponding to the gap area with low-amount heat of 1 kW or less.

The laser head may adjust a focal diameter size to be larger (i.e., greater) than a reference diameter through focal area defocusing by adjusting a distance to the gap area.

The laser head may implement the focal area defocusing by adjusting a position of a lens and may implement a weaving motion through a means for adjusting an angle of the lens when the gap area has an area larger (i.e., greater) than a maximum focal diameter taken through the defocusing.

The gas sprayer may include a spray nozzle mounted at a side portion of the laser head to eject a shielding gas and a gas tank supplying the shielding gas through a gas hose connected to the spray nozzle.

The controller may determine 3D coordinates (x, y, z) corresponding to gap area by matching 3D shape coordinates for each of car bodies in multiple models to the set position on a robot coordinate system. The controller may also control the laser head to move to the position of the 3D coordinates through the robot.

The controller may control an operation (ON/OFF) of the gas sprayer to an operation synchronized with a low-output laser beam operation signal (ON/OFF) of the laser head.

The controller may control the laser head to reduce a moving speed of the laser head or temporarily stop the laser head in a gap section or area larger (i.e., greater) than a reference value in the finishing path for enhanced filling work.

Another embodiment of the present disclosure provides a gap finishing method for a car body using a low-output laser before the car body is put into an electrodeposition process. The gap finishing method includes: recognizing vehicle identification information (ID) corresponding to the car body mounted at a set position of a fixing jig unit; retrieving a laser processing condition corresponding to the vehicle ID from a database (DB); setting the retrieved laser processing condition as a finishing work condition; transporting a laser head mounted on a robot to a gap area of the car body during gap finishing work; and performing three-dimensional processing by emitting a low-output laser beam to the gap area through the laser head.

Performing the three-dimensional processing may include spraying a shielding gas to a position where the laser beam is emitted through a gas sprayer.

The laser processing condition may include a laser output, a voltage, a shielding gas flow rate, a laser focal diameter, a processing speed, a waveform (continuous wave), gap area information, a gap section, a finishing path, or a combination thereof.

The gap finishing method may further include, after performing the three-dimensional processing, checking whether there is a next gap area that requires finishing work when the three-dimensional processing is completed. When there is a next gap area that requires finishing work, the gap finishing method may further include transporting the laser head to the next gap area of the car body and repeating the three-dimensional processing control by emitting a low-output laser beam to the next gap area through the laser head. When there is no next gap area that requires finishing work, the gap finishing method may further include completing the gap finishing work corresponding to the car body.

The gap finishing method may further include, after completing the gap finishing work corresponding to the car body, when a vehicle ID recognized from a current car body is different from a vehicle model of a car body subjected to gap finishing work completed just before, changing the work condition according to a laser processing condition corresponding to the current vehicle ID (i.e., the vehicle ID recognized from the current car body).

According to an embodiment, it is advantageous that paint defects can be reduced. The exterior quality of the car body can be improved by finishing a gap using a low-output laser to fundamentally prevent a paint electrodeposition flow.

Further, it is advantageous that the output range of laser welding, which is vulnerable to thin plate materials, can be optimized, and the freedom of motion teaching can be increased by avoiding behavioral interference through the remote type laser header, providing precise processing performance for complicated structures or narrow gaps.

Further, it is advantageous that safety accidents can be prevented for workers with versatility by identifying gap areas for each of car bodies in multiple models and multiple options and automating the control of the gap finishing facility including the robot and the laser head. As a result, an easy application to any mixed facility process is enabled.

### BRIEF DESCRIPTION OF THE DRAWINGS

FIG. 1 schematically illustrates a configuration of a gap finishing system for a car body using a low-output laser according to an embodiment of the present disclosure.

FIG. 2 illustrates a gap area of a car body and a gap section motion teaching state by enlarging portion “A” according to an embodiment of the present disclosure.

FIG. 3 illustrates a state in which a focal position of a low-output laser beam is adjusted through a cross section of portion “B” of FIG. 2 according to an embodiment of the present disclosure.

FIG. 4 illustrates a state of a finished portion according to a fine welding pattern of a laser head according to an embodiment of the present disclosure.

FIG. 5 is a flowchart schematically illustrating a gap finishing method for a car body using a low-output laser according to an embodiment of the present disclosure.

FIG. 6 illustrates a result of gap finishing work performed for each gap area of a car body according to an embodiment of the present disclosure.

FIG. 7 illustrates a welded state of a hemming part of a hood using a low-output laser according to an embodiment of the present disclosure and an enlarged cross-sectional view of a “portion C” thereof.

### DETAILED DESCRIPTION

Hereinafter, embodiments of the present disclosure are described in detail with reference to the accompanying drawings so that those having ordinary skill in the art to which the present disclosure pertains can carry out the technical concepts of the present disclosure.

The terms used herein are only for the purpose of describing particular embodiments and are not intended to limit the present disclosure. It is also to be understood that the terms such as “comprise,” “comprising,” “include,” “including,” and the like, when used herein, specify the presence of stated features, integers, steps, operations, elements and/or components. Such terms do not preclude the presence of or addition of one or more other features, integers, steps, operations, elements, components, and/or combinations thereof. As used herein, the term “and/or” includes any one and all combinations of the associated listed items.

Throughout the specification, the terms such as “first”, “second”, “A”, “B”, “(a)”, “(b)”, and the like may be used in describing various elements, but the elements should not be limited by the terms. These terms are only for distinguishing the elements from other elements, and the nature or the sequence or order of the elements should not be limited by the terms.

Throughout the specification, it should be understood that, when one element is referred to as being “connected” or “coupled” to another element, the elements may be directly connected or coupled to each other, or the elements may be connected or coupled to each other with an intervening component therebetween. On the other hand, it should also be understood that, when one element is referred to as being “directly connected” or “directly coupled” to another element, there is no intervening component therebetween.

The terms used throughout the specification are only for the purpose of describing embodiments and are not intended to limit the present disclosure. Singular expressions include plural expressions unless the context clearly dictates otherwise.

Additionally, it should be understood that one or more of the methods or the aspects thereof that are described below may be implemented by at least one controller. The term “controller” may refer to a hardware device including a memory and a processor. The memory is configured to store program commands and the processor is specially programmed to execute program commands in order to perform one or more processes to be described in more detail below. The controller may control operations of units, modules, parts, devices, or things similar thereto as described herein. Further, it should be understood that the methods to be described below may be executed by a device including a controller together with one or more other components as recognized by those having ordinary skill in the art.

When a component, controller, unit, module, part, device, element, apparatus, or the like of the present disclosure is described as having a purpose or performing an operation, function, or the like, the component, controller, unit, module, part, device, element, apparatus, or the like should be considered herein as being “configured to” meet that purpose or to perform that operation or function.

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

Hereinbelow, a low-output laser processing system and method for preventing electrodeposition flow on a car body according to an embodiment of the present disclosure is described in detail with reference to the drawings.

As a way to solve the shortcomings of the conventional art mentioned in the Background section, the present disclosure provides a technology relating to a gap finishing system for a car body that fundamentally blocks an electrodeposition liquid flow path by mechanically (structurally) closing the gap in the car body through laser welding.

The present disclosure sets goals in consideration of the following two problems to implement an optimized gap finishing system for a car body.

First, a laser welding system generally used for a car body is a high-output laser facility of about 4 to 6 KW or more and is mainly used for the purpose of replacing closed-section welding, piercing, or the like. However, the high-output laser facility is accompanied by excessive heat, which causes excessive melting of panels, pinholes, fish bones (iron thorns), and the like in the car body, making it impossible to finish fine gaps. In addition, when using laser brazing that generally considers appearance, there is a problem in that an increase in auxiliary material cost is excessive because copper wires are used rather than melting a base material during bonding.

Therefore, a first goal according to an embodiment of the present disclosure is to provide a gap finishing system for a car body using a low-output laser to support the processing of parts in local areas (for example, 2.0 mm or less) without using wires.

Second, since gaps to be finished in the car body are located on different three-dimensional surfaces (positions), automation is necessary because manual processing takes excessive work time, increases the dispersion of part processing quality, and has a risk of worker injury. In addition, a fine gap area of the car body where an electrodeposition flow occurs is difficult to access because the relevant section is short and interference between parts may occur. It is difficult to apply existing guide pin tracking, vision tracking, or the like to the fine gap area of the car body where an electrodeposition flow occurs (this is also a reason why the contact-type welding technology is not used in the present disclosure).

Therefore, a second goal according to an embodiment of the present disclosure is to provide a technology relating to a gap finishing system for a car body enabling stable low-output laser welding by absorbing (e.g., accommodating or compensating for) robot errors at ends of panels in the car body during automation without requiring a separate tracking technology.

Hereinbelow, a gap finishing system for a car body using a low-output laser according to an embodiment of the present disclosure is described.

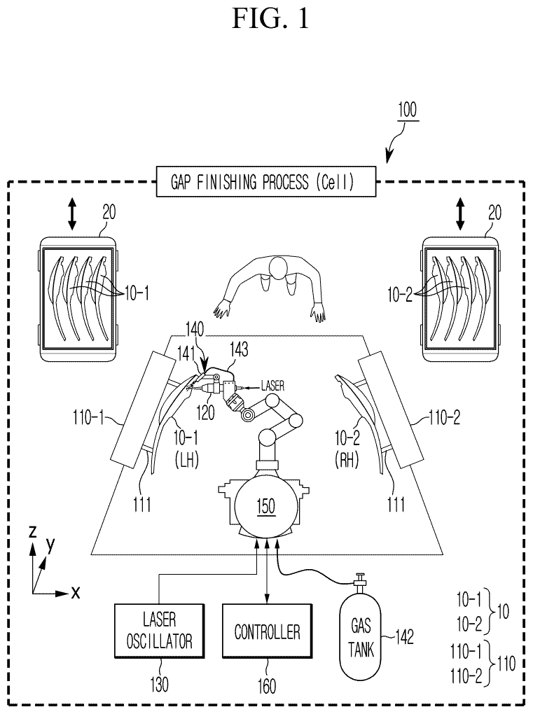

FIG. 1 schematically illustrates a configuration of a gap finishing system for a car body using a low-output laser according to an embodiment of the present disclosure.

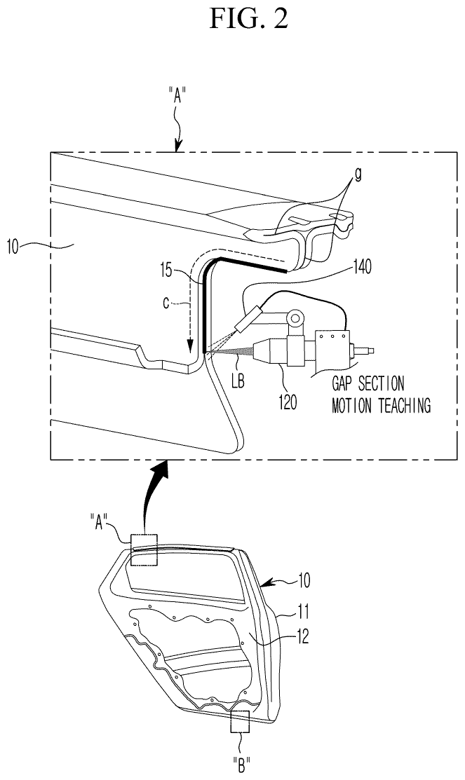

FIG. 2 illustrates a gap area of a car body and a gap section motion teaching state by enlarging portion “A” according to an embodiment of the present disclosure.

Referring to FIGS. 1 and 2, a gap finishing system 100 for a car body using a low-output laser according to an embodiment of the present disclosure includes a car body 10 transported to a set position for gap finishing work before entering an electrodeposition process. The gap finishing system 100 includes: a fixing jig unit 110 regulating the car body 10 seated at the set position through a clamp 111; a laser head 120 emitting a low-output (low-heat amount) laser beam to a gap area g of the car body 10 for three-dimensional processing to prevent a flow of an electrodeposition liquid; a laser oscillator 130 supplying a low-output laser light source to the laser head 120; a gas sprayer 140 spraying a shielding gas to a position where the laser beam is emitted; and a controller 160 controlling the three-dimensional processing operation by moving the laser head 120 mounted on an end effector of an articulated robot 150 to the gap area g of the car body 10.

Referring to the enlarged view of portion “A” in FIG. 2, the gap finishing system 100 for the car body using the low-output laser according to an embodiment of the present disclosure is applied to a gap finishing process (cell) in a smart factory capable of mixed production of multiple vehicle models, while a vehicle production line (process) is divided into cell units.

The gap finishing process refers to a pre-treatment process for fundamentally blocking (suppressing) a paint electrodeposition flow path before putting the car body 10 into an electrodeposition process.

The car body 10 includes panels forming the exterior of the vehicle and parts in which the panels are assembled with components. Hereinafter, in an embodiment of the present disclosure, for convenience of explanation, it is assumed that the car body 10 is a door. Since the car body 10 and the door 10 may be replaced with each other, they are denoted by the same reference numeral.

Before being put into the electrodeposition process, the door 10 is loaded on a pallet and transported to the gap finishing process (Cell) of the present disclosure through a logistics transport means 20. The logistics transport means 20 may be an automated guided vehicle (AGV) or an autonomous mobile robot (AMR).

The fixing jig unit 110 includes a first jig 110-1 on which a first door 10-1 is mounted on a left-hand (LH) side and a second jig 110-2 on which a second door 10-2 is mounted on a right-hand (RH) side, which are arranged symmetrically with respect to the robot 150.

The robot 150 may be formed of a multi-joint manipulator with at least six axes.

During the gap finishing work, the robot 150 transports the laser head 120 to the gap area g of the door 10 and moves the laser head 120 along a finishing path c set by gap section motion teaching.

During the gap section motion teaching of the robot 150, a finishing path may be created by setting welding positions with a laser pointer, which serving as a guide, being attached to the laser head 120, and connecting the plurality of welding positions to one another. Therefore, unlike the contact-type welding method, a teaching motion and a finishing path can be set by staring at the position of the laser pointer without performing separate tracking. In addition, since the present disclosure uses a low-output laser, the moving speed (processing speed) of the laser head 120 may be further set for each gap section (finishing path) during the gap section motion teaching.

The robot 150 may keep a constant focal distance between the gap section of the car body 10 and the laser head 120 by changing its kinematic posture. The gap areas g include all areas where the electrodeposition liquid may remain, e.g., boundary parts between a plurality of panels such as an outer panel 11 and an inner panel 12 of the door 10, flanges, hemming parts, overlapping parts of bent panels, and slit holes between panels. The gap areas g may be set differently depending on a vehicle information number (VIN) and an installation location (FL, FR, RL, RR).

The laser head 120 remotely emits a low-output laser beam LB to each of the gap areas g formed at various positions of the door 10 without wires, which are used conventionally, to partially melt the gap area g so that the gap area g is processed to be blocked. The low-output laser beam LB may process a local area corresponding to the gap area g with low-amount heat of 1 kW or less supplied from the laser oscillator 130.

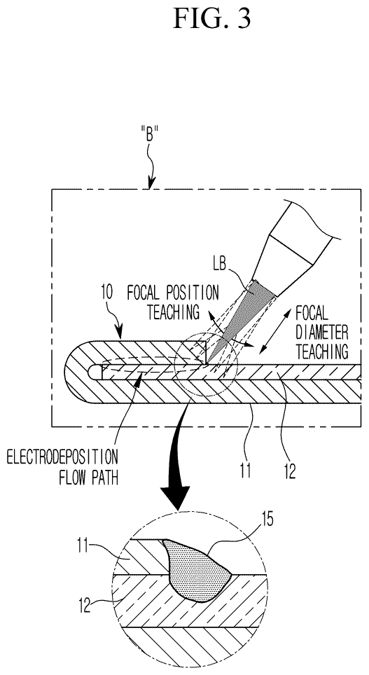

FIG. 3 illustrates a state in which a focal position and a focal diameter of a low-output laser beam LB is taught through a cross section of portion “B” of FIG. 2 according to an embodiment of the present disclosure.

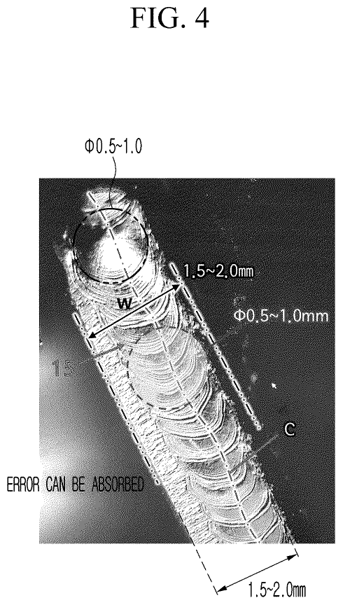

FIG. 4 illustrates a state of a finished portion subjected to low-output laser processing by a laser head according to an embodiment of the present disclosure.

Referring to FIGS. 3 and 4, even if a finishing path c is set through the gap section motion teaching of the robot 150, an error may occur in the focal position of the laser beam LB of the laser head 120 depending on a tolerance of assembly environment, equipment, or component.

In order to reduce such an error, the robot 150 performs focal position teaching for finely adjusting a focal position of the laser beam LB from the laser head 120 in a width (w) direction of the finishing path c and focal diameter teaching for adjusting a distance to the gap area g.

The robot 150 enables the laser head 120 to emit a low-output laser beam LB while moving at a constant processing speed (e.g., 50 mm/s) along the finishing path c to process the gap area g. The ‘processing’ of the gap area has the same meaning as ‘welding’, ‘finishing’, or ‘blocking’ the gap area.

The laser head 120 may create a screw-shaped welding pattern finished portion 15 having a laser focal diameter size along a length direction of the finishing path c. The finished portion 15 may be formed by partially melting the gap area g using a low-output laser beam LB, thereby fundamentally blocking an electrodeposition liquid flow path.

In this way, the laser head 120, which is a relatively small-scale low-output laser facility, may finely processing the gap area g in a remote manner, thereby absorbing (e.g., accommodating or compensating for) a car body assembling tolerance and a robot teaching error. For example, while a conventional reference focal diameter size of a laser beam LB is 0.1 mm, the laser head 120 according to the present disclosure can adjust a focal diameter size in a range of 0.5 to 1.0 mm through focal area defocusing by adjusting a distance to the gap area g. Therefore, it is possible to absorb (e.g., accommodate or compensate for) a car body assembling tolerance and a robot teaching error, thereby ensuring precise gap finishing performance.

In addition, the laser head 120 may implement defocusing by adjusting a position of a lens. Further, the laser head 120 may implement a weaving motion through a means for adjusting an angle of the lens when the gap area g has an area larger than a maximum focal diameter taken through the defocusing. Therefore, it is possible to laser-process an area larger than the maximum focal diameter size taken through defocusing.

The gas sprayer 140 includes a spray nozzle 141 mounted at a side portion of the laser head 120 to eject a shielding gas, and a gas tank 142 supplying the shielding gas through a gas hose 143 connected to the spray nozzle 141. As the shielding gas, nitrogen gas may be used.

The gas sprayer 140 serves to suppress an occurrence of a spatter or an iron thorn around the gap by surrounding a gap-processed portion with a shielding gas sprayed when a low-output laser beam is emitted from the laser head 120. Therefore, it is possible to secure uniform appearance and finishing performance according to the three-dimensional processing operation of the laser head 120.

The controller 160 is a computing system controlling an overall operation of the gap finishing system 100 for the car body using the low-output laser according to an embodiment of the present disclosure.

The controller 160 determine 3D coordinates (x, y, z) corresponding to gap area g by setting a robot coordinate system in which the laser head 120 is movable based on an installation position of the robot 150, and matching 3D shape coordinates for each of doors of car bodies 10 in multiple models and multiple options to the set position on the robot coordinate system. Then, the controller 160 may control the laser head 120 to move to the position of the 3D coordinates through the robot 150. The 3D shape coordinates of the car body may be derived based on at least one of 3D design data, an actual 3D model, or a combination thereof.

In addition, the controller 160 sets a finishing path c through the gap section motion teaching of the robot 150. The controller 160 may first set a finishing path c for each gap area of the first door 10-1, and then set a finishing path c for each gap area of the second door 10-2 having a symmetrical structure with the first door 10-1 to be the same as that of the first door 10-1 in a mirroring manner.

Therefore, the controller 160 may move the laser head 120 to various gap areas g of the door 10 by controlling a kinematic posture of the robot 150 The controller 160 may also control gap finishing work by emitting a low-output laser beam LB along the finishing path c.

In addition, the controller 160 may control an operation (ON/OFF) of the gas sprayer 140 to an operation synchronized with a low-output laser beam operation signal (ON/OFF) of the laser head 120.

In addition, the controller 160 may control the robot 150 to change a focal size of the low-output laser beam LB, if necessary, by adjusting a focal distance between the gap section of the car body 10 and the laser head 120.

In addition, the controller 160 may control the laser head 120 to reduce a moving speed of the laser head 120 or temporarily stop the laser head 120 in a gap section or area larger than a reference value in the finishing path c for enhanced filling work.

The controller 160 may control gap finishing work for the first door 10-1 on the left-hand (LH) side and the second door 10-2 on the right-hand (RH) side, which are arranged symmetrically, sequentially using one robot 150 installed at the center and the laser head 120 thereof.

The controller 160 described above may be implemented with one or more processors operating according to a set program. The set program may be programmed to perform each step of a gap finishing method for a car body using a low-output laser according to an embodiment of the present disclosure.

The gap finishing method for the car body using the low-output laser is described in more detail with reference to the drawings below.

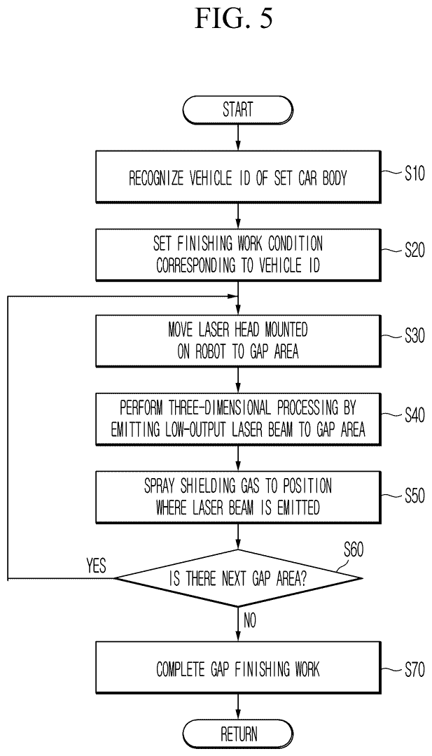

FIG. 5 is a flowchart schematically illustrating a gap finishing method for a car body using a low-output laser according to an embodiment of the present disclosure.

Referring to FIG. 5, the gap finishing method for the car body using the low-output laser according to an embodiment of the present disclosure is described, for when, before being put into an electrodeposition process, the car body 10 has been transported to a gap finishing process (Cell) that allows mixed production work.

The controller 160 recognizes vehicle identification information (ID) corresponding to the car body 10 mounted at a set position of the fixing jig unit 110 (S10). The vehicle ID may include a vehicle information number (VIN) and an installation location (e.g., FL, FR, RL, RR) of the car body 10 and may be confirmed from a specific tag (a barcode or a QR code) or a list of transported parts received from a transport means (an AGV or an AMR).

The controller 160 may retrieve a laser processing condition corresponding to the vehicle ID from a database (DB). The controller 160 may set the retrieved laser processing condition as a finishing work condition. Further, the controller 160 may stand by to start work (S20). For example, the laser processing condition may include at least one of a laser output (300 W to 1 Kw), a voltage (5 to 10 V), a shielding gas flow rate (5 to 8 L/min), a laser focal diameter (0.5 to 1.0 mm), a processing speed (50 mm/s), a waveform (continuous wave), a gap area (x, y, z coordinates), a gap section, a finishing path c, or a combination thereof.

The controller 160 may move the laser head 120 mounted on the robot 150 to a gap area g of the car body 10 during gap finishing work (S30). The controller 160 may also perform three-dimensional processing by emitting a low-output laser beam to the gap area g through the laser head 120 (S40). The controller 160 may finish the gap area g by emitting the low-output laser beam LB in a circular fine welding pattern P while moving the laser head 120 along a finishing path c set to correspond to a gap section.

In addition, the controller 160 may spray a shielding gas to a position where the laser beam is emitted through the gas sprayer 140 (S50).

When the three-dimensional processing is completed, the controller 160 checks whether there is a next gap area g that requires finishing work (S60).

When there is a next gap area g that requires finishing work (S60; Yes), the controller 160 may return to step S30 and transport the laser head 120 to the next gap area g of the car body 10 and may repeat the three-dimensional processing control by emitting a low-output laser beam to the next gap area g through the laser head 120. In other words, the controller 160 may repeat steps S30 to S50 until all of the finishing work set for the car body 10 is completed.

On the other hand, in step S60, when all of the set finishing work is completed and there is no next gap area g (S60; No), the controller 160 may complete the gap finishing work corresponding to the car body 10 (S70). The controller 160 may bring the robot 150 and the laser head 120 back to their initial positions, return, and stand by until a next work target car body 10 is set.

In step S20 after the return, if a vehicle ID recognized from a current car body 10 is different from a vehicle model of a car body subjected to gap finishing work completed just before, the controller 160 may change the work condition according to a laser processing condition corresponding to the current vehicle ID.

In addition, when the car bodies 10-1 and 10-2 are arranged symmetrically on the left and right sides, respectively, with respect to one robot 150 installed at the center as illustrated in FIG. 1, the controller 160 may perform gap finishing work for the first door 10-1 on the left-hand (LH) side and the second door 10-2 on the right-hand (RH) side sequentially according to the gap finishing method described above.

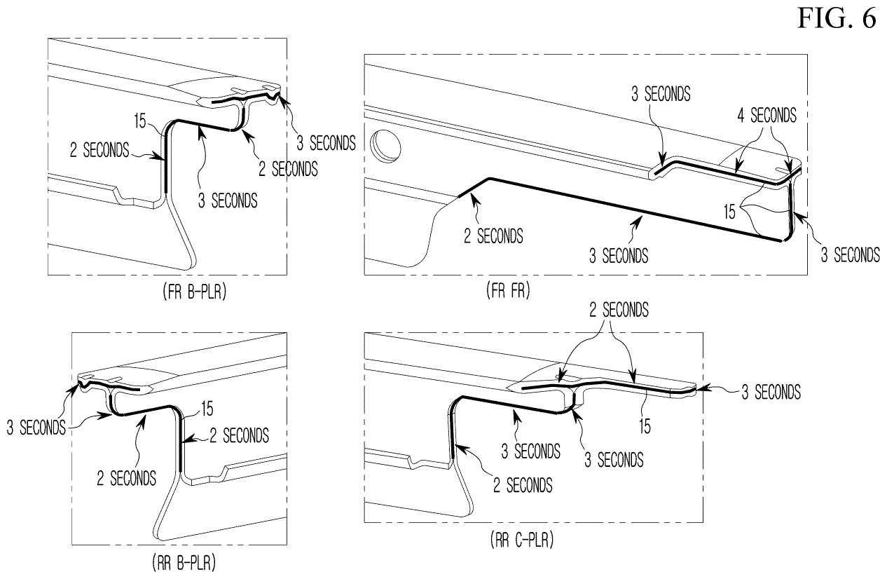

FIG. 6 illustrates a result of gap finishing work performed for each gap area of a car body according to an embodiment of the present disclosure.

Referring to FIG. 6, a result of gap finishing work performed for various gap areas (e.g., FR B-PLR, FR FR, RR B-PLR, and RR C-PLR) of the car body 10 using the gap finishing system 100 for the car body using the low-output laser according to an embodiment of the present disclosure is shown.

The gap finishing system 100 is advantageous in that the overall cycle time can be reduced, because it takes a few seconds to complete the finishing work for each gap section of the area where different electrodeposition flows occur using the laser head 120 mounted on the robot 150.

Although an embodiment of the present disclosure has been described above assuming that the car body is a door, the present disclosure should not be limited to the embodiment described above and may be applied to various other car body parts.

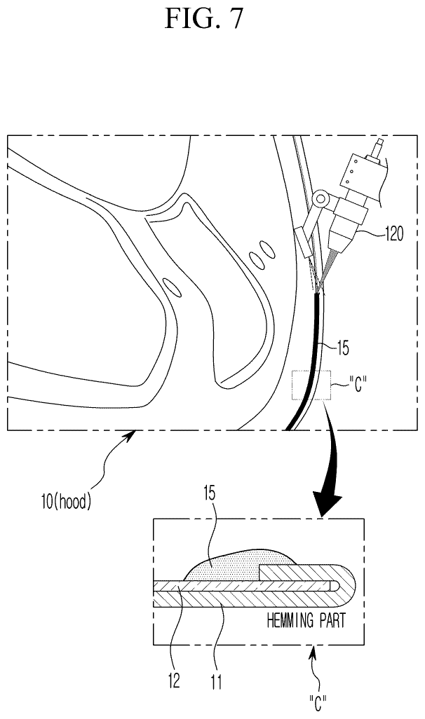

For example, FIG. 7 illustrates a welded state of a hemming part of a hood using a low-output laser according to an embodiment of the present disclosure and an enlarged cross-sectional view of a “portion C” thereof.

Referring to FIG. 7, the gap finishing system 100 for the car body according to an embodiment of the present disclosure may form a finished portion 15 by emitting a low-output laser beam along a length direction of a hemming part of a hood where the outer plate 11 and the inner plate 12 of the car body 10 overlaps using the laser head 120 mounted on the robot 150.

This is advantageous in that electrodeposition bubbles can be fundamentally prevented from being leaked from a gap of an overlapping portion between the outer plate 11 and the inner plate 12. Also, a white sealer applied to seal the hemming part can be eliminated. Therefore, the finishing of the hemming part of the car body can be automated, and costs can be reduced by eliminating the conventional white sealer treatment process.

According to an embodiment of the present disclosure described above, it is advantageous that a paint electrodeposition flow can be fundamentally suppressed by finishing gaps in the car body using a low-output laser as a pre-processing technology over the conventional post-processing technology for the paint electrodeposition flow, thereby fundamentally preventing an actual paint electrodeposition flow with a 0% occurrence rate.

In addition, it is advantageous that the output range of laser welding, which is vulnerable to thin plate materials, can be optimized. Also, the freedom of motion teaching can be increased by avoiding behavioral interference through the remote type laser header, providing precise processing performance for complicated structures or narrow gaps.

In addition, it is advantageous that safety accidents can be prevented for workers with versatility by identifying gap areas for each of car bodies in multiple models and multiple options and automating the control of the gap finishing facility including the robot and the laser head. As a result, an easy application to any mixed facility process is enabled.

An embodiment of the present disclosure may be implemented through the device and/or method described above. An embodiment of the present disclosure may also be implemented through a program for realizing a functions corresponding to the configuration in an embodiment of the present disclosure, a recording medium on which the program is recorded, or the like. This may be easily implemented by any person having ordinary skill in the art to which the present disclosure pertains from the embodiment described above.

Although embodiments of the present disclosure have been described in detail above, the scope of the present disclosure is not limited thereto. Various modifications and improvements made by those having ordinary skill in the art to which the present disclosure pertains using the basic concept of the present disclosure defined in the following claims also fall within the scope of the present disclosure.

### DESCRIPTION OF SYMBOLS

10: car body or door
10-1, 10-2; first door, second door
11, 12: outer plate, inner plate
15: finished portion
20: logistics transport means
100: gap finishing system for car body
110: fixing jig unit
110-1, 110-2: first jig, second jig
120: laser head
130: laser oscillator
140: gas sprayer
141: spray nozzle
142: gas tank
143: gas hose
150: robot
160: controller
LB: low-output laser beam
c: finishing path
g: gap area

What is claimed is:

1. A gap finishing system for a car body using a low-output laser, the gap finishing system comprising:
a fixing jig unit configured to regulate the car body seated at a set position for gap finishing work through a clamp;
a laser head configured to emit a low-output laser beam to a gap area of the car body for three-dimensional processing to prevent a flow of an electrodeposition liquid;
a laser oscillator configured to supply a low-output laser light source to the laser head;
a gas sprayer configured to spray a shielding gas to a position where the laser beam is emitted; and
a controller configured to control operation of the three-dimensional processing by moving the laser head mounted on an end effector of an articulated robot to the gap area of the car body.

2. The gap finishing system of claim 1, wherein:
the fixing jig unit includes a first jig on which a first car body is mounted on a left-hand (LH) side and a second jig on which a second car body is mounted on a right-hand (RH) side; and
the first jig and the second jig is arranged symmetrically with respect to the robot.

3. The gap finishing system of claim 2, wherein, during the gap finishing work, the robot is configured to transport the laser head to the gap area of the car body and move the laser head along a finishing path set by gap section motion teaching.

4. The gap finishing system of claim 3, wherein, during the gap section motion teaching, the robot is configured to create the finishing path by setting a plurality of welding positions with a laser pointer attached to the laser head and connecting the plurality of welding positions to one another.

5. The gap finishing system of claim 3, wherein the robot is configured to:
set a finishing path for each gap area of a first door; and
then set a finishing path for each gap area of a second door having a structure symmetrical to the first door such that the finishing path for each gap area of the second door is the same as the finishing path for each gap area of the first door in a mirroring manner.

6. The gap finishing system of claim 3, wherein the robot is configured to perform focal position teaching for adjusting a focal position of the laser beam from the laser head in a width direction of the finishing path and focal diameter teaching for adjusting a distance to the gap area.

7. The gap finishing system of claim 1, wherein the laser head is configured to remotely emit the low-output laser beam to the gap area formed based on a structure of the car body to partially melt the gap area such that the gap area is processed to be blocked.

8. The gap finishing system of claim 7, wherein the laser head is configured to remotely emit the low-output laser beam processing a local area corresponding to the gap area with low-amount heat of 1 kW or less.

9. The gap finishing system of claim 1, wherein the laser head is configured to adjust a focal diameter size to be greater than a reference diameter through focal area defocusing by adjusting a distance to the gap area.

10. The gap finishing system of claim 9, wherein the laser head is configured to implement the focal area defocusing by adjusting a position of a lens and implement a weaving motion through adjusting an angle of the lens when the gap area has an area greater than a maximum focal diameter taken through the focal area defocusing.

11. The gap finishing system of claim 1, wherein the gas sprayer includes:
a spray nozzle mounted at a side portion of the laser head and configured to eject a shielding gas; and
a gas tank configured to supply the shielding gas through a gas hose connected to the spray nozzle.

12. The gap finishing system of claim 1, wherein the controller is configured to:
determine three-dimensional (3D) coordinates corresponding to the gap area by matching 3D shape coordinates for each of car bodies in multiple models to the set position on a robot coordinate system; and
control the laser head to move to the position of the 3D coordinates through the robot.

13. The gap finishing system of claim 1, wherein the controller is configured to control an operation of the gas sprayer to an operation synchronized with a low-output laser beam operation signal of the laser head.

14. The gap finishing system of claim 1, wherein the controller is configured to control the laser head to reduce a moving speed of the laser head or temporarily stop the laser head in a gap section or area greater than a reference value in a finishing path for enhanced filling work.

15. A gap finishing method for a car body using a low-output laser before the car body is put into an electrodeposition process, the gap finishing method comprising:
recognizing vehicle identification information (ID) corresponding to the car body mounted at a set position of a fixing jig unit;
retrieving a laser processing condition corresponding to the vehicle ID from a database (DB);
setting the retrieved laser processing condition as a finishing work condition;
transporting a laser head mounted on a robot to a gap area of the car body during gap finishing work; and
performing three-dimensional processing by emitting a low-output laser beam to the gap area through the laser head.

16. The gap finishing method of claim 15, wherein performing the three-dimensional processing includes spraying a shielding gas to a position where the laser beam is emitted through a gas sprayer.

17. The gap finishing method of claim 15, wherein the laser processing condition includes a laser output, a voltage, a shielding gas flow rate, a laser focal diameter, a processing speed, a waveform (continuous wave), gap area information, a gap section, a finishing path, or a combination thereof.

18. The gap finishing method of claim 15, further comprising, after performing the three-dimensional processing:
checking whether there is a next gap area that requires finishing work when the three-dimensional processing is completed; and
when there is a next gap area that requires finishing work, transporting the laser head to the next gap area of the car body and repeating the three-dimensional processing control by emitting a low-output laser beam to the next gap area through the laser head; or
when there is no next gap area that requires finishing work, completing the gap finishing work corresponding to the car body.

19. The gap finishing method of claim 18, further comprising:
after the completing of the gap finishing work corresponding to the car body, when a vehicle ID recognized from a current car body is different from a vehicle model of a car body subjected to gap finishing work completed just before, changing the work condition according to a laser processing condition corresponding to the vehicle ID recognized from the current car body.
